(19) United States
(12) Patent Application Publication
(10) Pub. No.: US 2006/0204793 A1
(43) Pub. Date: Sep. 14, 2006

(54) Process for manufacturing magnetic material, magnetic material and high density magnetic recording medium

(75) Inventors: Takashi Koike, Kanagawa (JP); Koukichi Waki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/355,170

(22) Filed: Feb. 16, 2006

(30) Foreign Application Priority Data
Mar. 9, 2005 (JP) 2005-066135

(51) Int. Cl. G11B 5/65

(52) U.S. Cl. 428/836; 148/105

(57) ABSTRACT

A process for manufacturing a magnetic material, comprising: coating a nanoparticle dispersion containing alloy nanoparticles capable of forming a ferromagnetic ordered alloy phase, and a fusion inhibitor on a support to form a coated film of a nanoparticle magnetic layer, and heat-treating the coated film to ferromagnetize the alloy nanoparticles. Further, a magnetic material comprising a support and a nanoparticle magnetic layer of a nanoparticle dispersion coated thereon, wherein the nanoparticle dispersion comprises alloy nanoparticles capable of forming a ferromagnetic ordered alloy phase and a fusion inhibitor, is provided.

### CROSS-REFERENCE TO RELATED APPLICATION

This application claims priority under 35 USC 119 from Japanese Patent Application No. 2005-66135, the disclosure of which is incorporated by reference herein.

### BACKGROUND OF THE INVENTION

1. Field of the Invention

The present invention relates to a process for manufacturing a magnetic material, a magnetic material and a high density magnetic recording medium. More particularly, the present invention relates to a process for manufacturing a magnetic material, a magnetic material and a high density magnetic recording medium which can be used in MRAM (Magnetoresistive Random Access Memory) and the like.

2. Description of the Related Art

Magnetic recording media have widely been used as video tapes, computer tapes, disks and the like. In such magnetic recording media, it is necessary to decrease the particle size of a magnetic material in order to increase magnetic recording density. In a magnetic recording medium, when the mass of a ferromagnetic material remains constant, the level of noise decreases as the particle size becomes smaller.

A CuAu type or Cu₃Au type ferromagnetic ordered alloy has high crystalline magnetic anisotropy due to strain generated at the time of being ordered and exhibits ferromagnetic properties even when the particle size thereof is made small and is, therefore, a promising material for enhancing magnetic recording density.

When an alloy nanoparticle capable of forming a CuAu type or Cu₃Au type alloy is formed, it has the structure of a face-centered cubic crystal. The face-centered cubic crystal ordinarily exhibits a soft magnetic property or a paramagnetic property. A material which is soft magnetic or paramagnetic is not appropriate for application to a recording medium. Accordingly, in order to obtain a ferromagnetic ordered alloy having a coercive force of 95.5 KA/m or more, it has been necessary to perform a heat treatment on the alloy nanoparticles at a temperature of 500° C. or more. However, it has been difficult to disperse alloy nanoparticles on a support under the condition of keeping the original diameter after heat treatment.

In addition, there is also a method in which a magnetic recording medium in which alloy nanoparticles were applied on the support, was subjected to a heat treatment. As a support, an organic support such as polyesters such as polyethylene terephthalate and polyethylene naphthalate; polyolefins; cellulose triacetate; polycarbonate; polyamides (inclusive of aliphatic polyamides and aromatic polyamides such as aramids); polyimide; polyamideimide; polysulfone; or polybenzoxazole, or an inorganic support such as glass, alumina, Si, or SiO₂. At the time of heat treatment, there have been problems with thermal resistance of the support itself when an organic support was used, while there was also a problem of strain or the like being generated when an inorganic support was subjected to a thermal treatment. Thus, such supports as described above have not been put to practical use.

In order to avoid such problems, a method using heat treatment by laser beam so as to reduce the influence of heat on a support is known (see, for example, Japanese Patent Application Laid-Open (JP-A) No. 2003-260409). Heating by laser beam enables a ferromagnetic ordered alloy to be obtained irrespective of the nature of a support.

However, ferromagnetization by heating with laser beam also causes fusion in a portion of nanoparticles after treatment, and a desired particle diameter cannot be maintained in some cases. As a result, the expected magnetic recording density is not obtained. In addition, in heat treatment other than by laser beam, there has been the problem that it is necessary to finely calibrate heating conditions in order to avoid fusion in heat treatment.

### SUMMARY OF THE INVENTION

Accordingly, the present invention has been made to solve the aforementioned problems. That is, the present invention provides a process for manufacturing a magnetic material by which a magnetic material comprising magnetic nanoparticles of a ferromagnetic ordered alloy phase having a desired particle diameter can be effectively obtained, such a magnetic material and a high density magnetic recording medium.

A first aspect of the invention is a process for manufacturing a magnetic material, comprising: coating a nanoparticle dispersion containing alloy nanoparticles capable of forming a ferromagnetic ordered alloy phase, and a fusion inhibitor on a support to form a coated film of a nanoparticle magnetic layer, and heat-treating the coated film to ferromagnetize the alloy nanoparticles.

A second aspect of the invention is the process for manufacturing a magnetic material according to the first aspect, wherein the fusion inhibitor is an inorganic material capable of withstanding a temperature of at least 500° C., and is soluble in a dispersing solvent of a nanoparticle dispersion.

A third aspect of the invention is the process for manufacturing a magnetic material according to the first aspect, wherein the fusion inhibitor is a non-magnetic metal oxide.

A fourth aspect of the invention is the process for manufacturing a magnetic material according to the second aspect, wherein the fusion inhibitor is a non-magnetic metal oxide.

A fifth aspect of the invention is the process for manufacturing a magnetic material according to the first aspect, wherein the fusion inhibitor is at least one inorganic material selected from silica, titania, and polysiloxane.

A sixth aspect of the invention is the process for manufacturing a magnetic material according to the first aspect, wherein an amount of the fusion inhibitor to be added is 1 to 50% relative to the total volume of the alloy nanoparticles.

A seventh aspect of the invention is the process for manufacturing a magnetic material according to the first aspect, wherein the alloy nanoparticles are alloy nanoparticles capable of forming a CuAu type or Cu₃Au type ferromagnetic ordered alloy phase.

An eighth aspect of the invention is the process for manufacturing a magnetic material according to the first aspect, wherein the heat treatment is performed by irradiation with laser beam.

A ninth aspect of the invention is the process for manufacturing a magnetic material according to the eighth aspect, wherein the irradiation with laser beam is oscillated from a laser beam oscillator which is disposed in an array manner.

A tenth aspect of the invention is a magnetic material comprising a support and a nanoparticle magnetic layer of a nanoparticle dispersion coated thereon, wherein the nanoparticle dispersion comprises alloy nanoparticles capable of forming a ferromagnetic ordered alloy phase and a fusion inhibitor.

An eleventh aspect of the invention is the magnetic material according to the tenth aspect, wherein a laser reflection layer is provided between the support and the nanoparticle magnetic layer.

A twelfth aspect of the invention is the magnetic material according to the tenth aspect, wherein the fusion inhibitor is an inorganic material capable of withstanding a temperature of at least 500° C., and is soluble in a dispersing solvent of a nanoparticle dispersion.

A thirteenth aspect of the invention is the magnetic material according to the tenth aspect, wherein the fusion inhibitor is a non-magnetic metal oxide.

A fourteenth aspect of the invention is the magnetic material according to the tenth aspect, wherein the fusion inhibitor is at least one inorganic material selected from silica, titania, and polysiloxane.

A fifteenth aspect of the invention is the magnetic material according to the tenth aspect, wherein an amount of the fusion inhibitor to be added is 1 to 50% relative to the total volume of the alloy nanoparticles.

A sixteenth aspect of the invention is the magnetic material according to the tenth aspect, wherein the alloy nanoparticles are alloy nanoparticles capable of forming a CuAu type or Cu₃Au type ferromagnetic ordered alloy phase.

A seventeenth aspect of the invention is a magnetic material manufactured by the process according to the first aspect.

An eighteenth aspect of the invention is a high density magnetic recording medium comprising a magnetic layer containing the magnetic material according to the tenth aspect.

A nineteenth aspect of the invention is a high density magnetic recording medium comprising a magnetic layer containing the magnetic material according to the seventeenth aspect.

### DETAILED DESCRIPTION OF THE INVENTION

The process for manufacturing a magnetic material of the invention comprises coating a nanoparticle dispersion containing alloy nanoparticles capable of forming a ferromagnetic ordered alloy phase and a fusion inhibitor on a support to form a coated film of a nanoparticle magnetic layer, and heat-treating the coated film to ferromagnetize alloy nanoparticles.

Hereinafter, the process for manufacturing a magnetic material will be explained in detail.

[Preparation of Alloy Nanoparticles]

In the invention, alloy nanoparticles capable of forming a ferromagnetic ordered alloy phase (hereinafter, also simply referred to as “alloy nanoparticles”) can be prepared by a vapor phase method or a liquid phase method, or other known alloy nanoparticle forming methods. In consideration of excellent mass production, a liquid phase method is preferable. As a liquid phase method, previously known methods can be applied. As a liquid phase method, when classified by precipitation method, there is an alcohol reduction method using a primary alcohol, a polyol reduction method using a divalent or trivalent alcohol, a thermal decomposition method, an ultrasound decomposition method, and a strong reduction method. In addition, when classified by reaction system, there is a polymer residing method, a high boiling point solvent method, a normal micelle method, and a reverse micelle method. It is preferable to apply a modified reduction method that improves on these methods and, among the reduction methods, a reverse micelle method is particularly preferable view of the fact that particle diameter is easily controlled.

[Reverse Micelle Method]

The reverse micelle method comprises at least (1) a reduction step of mixing two kinds of reverse micelle solutions and conducting reduction reaction and, (2) an aging step of aging the product obtained after the reduction step (1) the above at a predetermined temperature.

Each of the steps will be described below.

(1) Reduction Step

First, a reverse micelle solution (A) is prepared by mixing a non-aqueous organic solvent containing a surfactant with an aqueous solution of a reducing agent.

As the surfactant, an oil soluble surfactant may be used. Specific examples thereof include sulfonate salt type (for example, aerosol OT (manufactured by Tokyo Kasei Kogyo)), a quaternary ammonium salt type (for example, cetyltrimethyl ammonium bromide), and ether type (for example, pentaethylene glycol dodecyl ether). The amount of the surfactant in the non-aqueous organic solvent is preferably from 20 to 200 g/l.

The non-aqueous organic solvent dissolving the surfactant is preferably alkanes, ethers, or the like. The alkane is preferably alkanes having 7 to 12 carbon atoms. Specific examples of the alkanes include heptane, octane, nonane, decane, undecane, dodecane, and the like. As the ethers, diethyl ether, dipropyl ether, dibutyl ether, and the like are preferred.

As the reducing agent to be used in the present invention, alcohols; polyols; H₂; or compounds including HCHO, S₂O₆²⁻, H₂PO₂⁻, BH₄⁻, N₂H₅⁺, H₂PO₃⁻, or the like may be used alone or two or more of these reducing agent may be used in combination. The amount of the reducing agent in the aqueous solution is preferably from 3 to 50 mol based on 1 mol of the metal salt.

Herein, it is preferable that a mass ratio (water/surfactant) of water and a surfactant in a reverse micelle solution (A) is 20 or less. When the mass ratio is 20 or less, there is an advantage that production of precipitates is suppressed, and particle diameters are easily uniformed. The mass ratio is preferably 15 or less, more preferably 0.5 to 10. In addition, reverse micelle solutions in which the mass ratio and the raw materials used are changed if necessary may be prepared, and they may be used in combination with a reverse micelle solution (A).

Separately, a reverse micelle solution (B) may be prepared by mixing non-aqueous organic solvent containing a surfactant and an aqueous solution of a metal salt. The conditions (material to be used, concentration, etc.) for the surfactant and the non-aqueous organic solvent are the same as those for the reverse micelle solution (A). Further, the reverse micelle solution (B) may be identical with or different from the reverse micelle solution (A). Also, the mass ratio of the water and the surfactant in the reverse micelle solution (B) is the same as those in the reverse micelle solution (A), which may be identical with or different from the mass ratio in the reverse micelle solution (A).

In addition, reverse micelle solutions in which the mass ratio and the raw materials used are changed if necessary may be prepared and they may be used in combination with a reverse micelle solution (B).

It is preferable that a metal salt contained in an aqueous solution of metal salt is appropriately selected so that nanoparticles to be prepared can form a desired ferromagnetic ordered alloy. By appropriately selecting a metal salt, nanoparticles capable of forming a ferromagnetic ordered alloy comprising an alloy of a base metal and a noble metal can be prepared.

In the invention, examples of a ferromagnetic ordered alloy include a CuAu type ferromagnetic ordered alloy, a Cu₃Au type ferromagnetic ordered alloy and a rare earth-based ferromagnetic alloy and, among them, a CuAu type ferromagnetic ordered alloy, and a Cu₃Au type ferromagnetic ordered alloy are preferable from a viewpoints of a magnetic anisotropy constant and oxidation resistance.

Examples of a CuAu type ferromagnetic ordered alloy include FeNi, FePd, FePt, CoPt and CoAu, and, FePd, FePt and CoPt are preferable. FePt is particularly preferable because it has a greatest magnetic anisotropy constant.

Examples of a Cu₃Au type ferromagnetic ordered alloy include Ni₃Fe, FePd₃, Fe₃Pt, FePt₃, CoPt₃, Ni₃Pt, CrPt₃, and Ni₃Mn, and FePd₃, FePt₃, CoPt₃, Fe₃Pd, Fe₃Pt and Co₃Pt are preferable.

As a rare earth-based ferromagnetic alloy, SmCo₅, Sm₂Co₁₇, Nd₃Fe₁₆B, Nd₂Fe₁₄B and Sm₂Fe₁₇N₃ are preferable. Since they have a tiny smallest stable particle diameter at which ferromagnetism can be maintained relative to heat fluctuation, they are preferred as a material for a high density magnetic recording medium. In addition, since these alloys are very easily oxidized, it is preferable to take strategy for antioxidation in a manufacturing process, such as covering of particles with an antioxidizing layer.

Specifically, examples of a metal salt capable of forming the ferromagnetic ordered alloy include H₂PtCl₆, K₂PtCl₄, Pt(CH₃COCHCOCH₃)₂, Na₂PdCl₄, Pd(OCOCH₃)₂, PdCl₂, Pd(CH₃COCHCOCH₃)₂, HAuCl₄, Fe₂(SO₄)₃, Fe(NO₃)₃, (NH₄)₃Fe(C₂O₄)₃, Fe(CH₃COCHCOCH₃)₃, NiSO₄, CoCl₂, Co(OCOCH₃)₂, Sm(CH₃COO)₃, SmCl₃, Sm(NO₃)₃, Sm₂(C₂O₄)₃, Sm₂(SO₄)₃, Nd(CH₃COO)₃, NdCl₃, Nd(NO₃)₃, Nd₂(C₂O₄)₃, Nd₂(SO₄)₃, H₂BO₃ and NaBH₄.

A concentration of metal salt (as a metal salt concentration) in an aqueous solution is preferably 0.1 to 1000 μmol/ml, more preferably 1 to 100 μmol/ml. When the concentration is lower than 0.1 μmol/ml, a production yield of the alloy nanoparticles is low, and therefore, it may not be practically suitable, while when the concentration exceeds 1000 μmol/ml, particle diameters of alloy nanoparticles prepared may be ununiform, both being not preferable.

In addition, it is preferable to lower a temperature of transformation into a ferromagnetic ordered alloy by adding a third element such as Sb, Pb, Bi, Cu, Ag and Zn to a binary alloy. Regarding these third elements, it is preferable to add a precursor of each third element to the metal salt solution in advance. An addition amount is preferably 1 to 30 atm %, more preferably 5 to 25 atm % relative to the total amount of the binary alloy and the third element. When the amount is less than 1 atm %, the transformation temperature may not be lowered, while when the amount exceeds 30 atm %, ferromagnetism may not be realized even after transformed into an ordered phase, both being not preferable.

The reverse micelle solutions (A) and (B) prepared as described above are mixed. The mixing method is not particularly limited, but it is preferably conducted by adding the reverse micelle solution (B) to the reverse micelle solution (A) while stirring the reverse micelle solution (A) considering the uniformity of the reduction. After the completion of mixing, the reduction reaction proceeds at a temperature that is preferably kept at a constant temperature set from within a range of from −5 to 30° C.

When the reduction temperature is lower than −5° C., it results in a problem that the aqueous phase causes coagulation to make the reduction reaction ununiform. When it exceeds 30° C., agglomeration or precipitation tends to occur to make the system instable. A reduction temperature is from 0 to 25° C. and, more preferably from 5 to 25° C.

The “constant temperature” means that when the temperature is assumed as T (° C.), it is in the range of T±3° C. Also, in such a case, it is defined that the upper limit and the lower limit for T are within the range of the reduction temperature (−5 to 30° C.).

It is necessary to appropriately set a time for a reduction reaction depending on an amount of a reverse micelle solution, and the time is preferably 1 to 30 minutes, more preferably 5 to 20 minutes. When the time is shorter than one minute, nucleation is insufficient, while when the time exceeds 30 minutes, particle growth initiates and particle diameters of prepared alloy nanoparticles may become un-uniform, both being not preferable.

Since the reduction reaction gives a significant effect on the mono-dispersibility of the particle size distribution, it is preferred that the reaction is conducted while stirring at a speed as high as possible. A preferred stirrer is a stirrer having high shearing force, specifically, a stirrer having a stirring blade basically of a turbine type or paddle type structure and, further, having a structure in which a sharp blade is attached at the end of the blade or at a position in contact with the blade, and in which the blade is rotated by a motor. Specifically, those apparatus such as a dissolver (manufactured by Tokushu Kika Kogyo), Omni mixer (manufactured by Yamato Scientific Institute), homogenizer (manufactured by SMT) etc. are useful. Mono-dispersed nanoparticles can be synthesized as a stable liquid dispersion by using the apparatus described above.

It is preferred that at least one dispersant having 1 to 3 amino groups, carboxyl groups, sulfonic acid groups, or sulfinic acid groups is added to at least one of the reverse micelle solutions (A) and (B) in an amount of from 0.001 to 10 mol based on one mol of metal nanoparticles.

The addition of the dispersant enables to production of nanoparticles having high mono-dispersibility and less agglomeration. When the addition amount is less than 0.001 mol, the mono-dispersibility of the alloy particles is less improved, while when it exceeds 10 mol, agglomeration may occur.

The dispersant is preferably an organic compound having a group adsorbed onto the surface of metal nanoparticles. Specific examples of the dispersant include those having 1 to 3 amino groups, carboxylic groups, sulfonic acid groups, or sulfinic acid group. The dispersants can be used alone or in combination. The dispersant having 1 to 3 amino groups or carboxyl groups is preferable. They include compounds represented by the following structural formula: R—NH₂, NH₂—R—NH₂, NH₂—R(NH₂)—NH₂, R—COOH, COOH—R—COOH, COOH—R(COOH)—COOH, R—SO₃H, SO₃H—R—SO₃H, SO₃H—R(SO₃H)—SO₃H, R—SO₂H, SO₂H—R—SO₂H, SO₂H—R(SO₂H)—SO₂H, or the like, in which R represents a linear, branched or cyclic saturated or unsaturated hydrocarbon.

Particularly preferred compound as the dispersant is oleic acid. The oleic acid is a well-known surfactant for the stabilization of colloid, and has been used for protecting Fe nanoparticles. Oleic acid has relatively long chain (e.g., that having 18 carbon chains with a length of 20 Å or less (2 nm or less)). Oleic acid is not an aliphatic group and has one double bond, and therefore, can give a steric hindrance important for counteracting strong magnetic interaction between particles. Similar long chained carboxylic acids such as erucic acid or linolic acid is also used, for example, long chained organic acids having 8 to 22 carbon atoms can be used alone or in combination. Since oleic acid is an easily available and inexpensive natural resource (such as olive oil), it is preferred. Further, oleyl amine derived from oleic acid is also a useful dispersant like the oleic acid.

In the reduction step described above, a base metal having a oxidation/reduction potential of about −0.2V (vs. N. H. E) or lower, such as Co, Fe, Ni, or Cr, in the CuAu-type or Cu₃Au-type ferromagnetic ordered alloy phase is reduced and precipitated at a micro size in a mono-dispersed state. Subsequently, in the temperature elevating stage and in the aging step described hereinafter, a noble metal having a oxidation/reduction potential of about −0.2V (vs. N. H. E) or more, such as Pt, Pd, or Rh is reduced and substituted by a base metal, and precipitated around the precipitated base metal as nuclei and at the surface thereof. The ionized base metal may be again reduced by the reducing agent and precipitated. By such repeated reduction, alloy nanoparticles capable of forming the CuAu-type or Cu₃Au-type ferromagnetic ordered alloy can be obtained.

(2) Aging Step

After the completion of the reduction, a temperature of the solution is elevated to an aging temperature. The aging temperature is preferably constant at a temperature of 30 to 90° C. and the temperature is set higher than the temperature in the reduction reaction. The aging time is preferably in the range of from 5 to 180 min. When the aging temperature and the aging time are deviated from the range described above toward the region of higher temperature and the longer time, agglomeration or precipitation tend to occur. On the other hand, when the aging temperature and the aging time towards the region of lower temperature and shorter time than the range described the above, the reaction is not completed and the composition changes. Preferred aging temperature and time are 40 to 80° C. and 10 to 150 min and, more preferred aging temperature and time are 40 to 70° C. and 20 to 120 min.

The term “constant temperature” has the same meaning as that in the reduction reaction (the “reduction temperature” should be read as “aging temperature”) and, particularly, preferably, the temperature is higher by 5° C. or more and more preferably, higher by 10° C. or more than the temperature of the reduction reaction, within the range of the aging temperature (30 to 90° C.). When it is not higher by more than 5° C., a composition having the desired formulation can not be obtained.

In the aging step described above, a noble metal is precipitated on the base metal precipitated by reduction in the reduction step. That is, since reduction of the noble metal occurs only on the base metal and the base metal and the noble metal are not precipitated separately, alloy nanoparticles capable of efficiently forming the CuAu type or Cu₃Au type ferromagnetic ordered alloy, can be prepared at high yield, and the composition ratio thereof can follow a formulation and can be controlled to a desired composition. Further, by properly controlling the stirring speed at the temperature upon aging, the particle size of the obtained alloy nanoparticles can be made to a desired size.

After aging, it is preferred to conduct a cleaning and dispersing step, that is, the resultant solution after the aging is cleaned with a mixed solution of water and a primary alcohol and is effected on a precipitating treatment with a primary alcohol to form precipitates, and then, the precipitates are dispersed with an organic solvent.

By the cleaning step, impurities are removed and thus, the coating ability upon forming the magnetic layer of the magnetic recording medium by coating can be improved further. The cleaning and the dispersing steps are conducted respectively at least once and, preferably, twice or more respectively.

The primary alcohol used for cleaning is not particularly limited, and methanol, ethanol, etc. is preferred. The mixing ratio of water/primary alcohol based on the volume is, preferably, in a range of from 10/1 to 2/1 and, more preferably, in a range of from 5/1 to 3/1.

When the ratio of water is higher, it is difficult to remove the surfactant. On the other hand, when the ratio of the primary alcohol is higher, this tends to cause agglomeration.

As described the above, alloy nanoparticles dispersed in a solution is obtained. The nanoparticles are monodispersed, and retains uniform dispersion without aggregation. In the first or second aspect of the invention, it is preferable that the alloy nanoparticles are alloy nanoparticles capable of forming a CuAu type or Cu₃Au type ferromagnetic ordered alloy.

An outermost layer of nanoparticles preferably comprises a noble metal from the viewpoint of oxidation inhibition, and, however, the nanoparticles are susceptible to being agglomerated. Therefore, in the present invention, an alloy of a noble metal and a base metal is preferably used.

It is possible to use a transmission electron microscope (TEM) for conducting a particle size evaluation of nanoparticles. For determination of a crystalline system of nanoparticles, electron diffraction by the TEM may be used, but it is preferable to use X-ray diffraction because the X-ray diffraction is higher accurate than the electron diffraction. For performing a composition analysis of an inside of nanoparticles; it is preferable to perform an evaluation by FE-TEM on which EDAX is attached, which is capable of finely focusing electron beams. For performing evaluation of magnetic properties of nanoparticles, a vibrating sample magnetometer (VSM) can be used.

(Coating)

Since nanoparticles prepared by the liquid phase method are in a state of being dispersed in a liquid, a solvent or the like is added to the liquid as required to allow a content of the nanoparticles in the resultant solution to be from 0.01 g/l to 0.1 g/l, thereby preparing a coating liquid (nanoparticle dispersion). The coating solution is applied on the support to form a coating film. A quantity of the coating solution to be applied is preferably from about 0.01 g/m² to about 1 g/m² depending on conditions such as content of nanoparticles.

Herein, as a solvent used for preparing a coating solution, the same solvents as non-aqueous organic solvents used in a step of preparing alloy nanoparticles, that is, alkanes and ethers can be used. Among them, from a viewpoint of solubility of a fusion inhibitor described hereinafter, heptane, octane, isooctane, nonane and decane are preferable.

In the invention, a fusion inhibitor as an addition component is contained in this coating solution. The fusion inhibitor can inhibit a fusion between alloy nanoparticles at heat treatment. The fusion inhibitor is soluble in a solvent for dispersing alloy nanoparticles, and is capable of withstanding temperature of at least 500° C., preferably. When the temperature limit of a fusion inhibitor is lower than 500° C., the fusion inhibitor is degraded upon heat treatment, and the fusion inhibiting effect may not be obtained. Further, the temperature limit refers to a temperature at which a fusion inhibitor initiates thermal degradation.

In addition, in view of application on a magnetic recording medium, a fusion inhibitor is preferably non-magnetic. As such fusion inhibitor, non-magnetic metal oxide is preferably used, and at least one kind of inorganic material selected from silica, titania, and polysiloxane is more preferable.

Specific examples of such fusion inhibitor include an organosilica sol (e.g. trade name: NANOTEK SiO₂, manufactured by C.I.KASEI. CO., LTD.), an organotitania sol (e.g. trade name: NANOTEK TiO₂, manufactured by C.I.KASEI. CO., LTD.), and a silicone resin (e.g. TREFIL R910, manufactured by Toray Dow Corning Silicone Co., Ltd.).

An amount of the fusion inhibitor to be added is preferably 1 to 50%, more preferably 2 to 30% relative to the total volume of alloy nanoparticles. When the amount is less than 1%, the effect as a fusion inhibitor may not be obtained, while when the amount is more than 50%, a fusion inhibitor may be aggregated and precipitated upon drying.

As a support, any of an inorganic material and an organic material can be used. In view of application on a hard disc, it is preferable to use an inorganic material and, in view of application on a magnetic tape and a floppy (registered trademark) disc, it is preferable to use an organic material.

As the inorganic support, Si, Al, Mg alloy such as Al—Mg or Mg—Al—Zn, glass, quartz, carbon, silicon, ceramics, etc. are used. The inorganic supports are excellent in impact resistance and have rigidity suitable to thinning or high speed rotating of the support. Further, the inorganic supports have greater heat resistance compared with organic supports.

As the organic support, polyesters such as polyethylene terephthalate and polyethylene naphthalate; polyolefins; cellulose triacetate, polycarbonate, polyamide (including aliphatic polyamide and aromatic polyamide such as aramid), polyimide, polyamide imide, polysulfone, polybenzoxazole; and the like can be used.

Typical coating methods such as air doctor coating, blade coating, rod coating, extrusion coating, air knife coating, squeeze coating, immersion coating, reverse roll coating, transfer roll coating, gravure coating, kiss coating, cast coating, spray coating, spin coating and the like can be utilized.

It is preferable that a drying step is conducted after coating. In a drying step, the conventional conditions may be applied, for example, it is possible to conduct the drying step at a temperature of 40 to 250° C. for 5 to 60 minutes in a hot air oven.

[Forming a Ferromagnetic Layer]

Nanoparticles capable of forming a ferromagnetic ordered alloy prepared by a liquid phase method or a vapor method is in a disordered phase. Generally, since ferromagnetism is not obtained in a disordered phase, it is necessary to perform heat treatment (annealing) in order to obtain an ordered phase. As a heat treating temperature, a transformation temperature at which an alloy constituting nanoparticles is transformed between ordered phase and disordered phase is obtained using differential thermal analysis (DTA), and it is necessary to perform heat treatment at a higher temperature than the transformation temperature.

An apparatus used in heat treatment may be generally a means which can heat nanoparticles at a desired temperature, for example, an electric furnace. In the case of an electric furnace, the heating is conducted at 350 to 500° C. for 5 to 300 minutes.

As heat treatment for effectively and simply ferromagnetizing the nanoparticles in the formation of a ferromagnetic layer irrespective of the kind of support, it is preferable to irradiate the coated film with laser beam. By irradiating a coated film with laser beam, only nanoparticles in a coated film can be selectively heated. For this reason, even when the transformation temperature of 500° C. or higher, an organic support used in a magnetic recording medium such as tape, a floppy (registered trademark) disk etc. can be also used. Further, even when a particular inorganic support such as glass, alumina, Si, SiO₂ etc. is used, distortion does not occur at heat treatment. In addition, heating with laser beam has a characteristic that a temperature raising rate and a cooling rate are high. Therefore, even when an organic material is used as a support, deformation or denaturation due to heat are prevented, fusion between nanoparticles are less than that in annealing with an electric furnace, and thus, a nanoparticle alloy phase can be ordered effectively in a short time.

As for a wavelength of the laser, those of from ultraviolet to infrared can be utilized; however, since the support of the organic material has absorbance in the ultraviolet region, it is preferable to use a laser beam having a wavelength from the visible light region to the infrared region.

An output of the laser is, preferably 0.1 W or more and more preferably 0.3 W or more for the purpose of heating the coated film in a short time. When the output is unduly high, nanopaticles separate from the support due to an ablation and the support of the organic material is suscetible to heat and, therefore, the output is preferably 3 W or less.

The lasers used in the present invention are not particularly limited, but examples of favorable lasers include an Ar ion laser, a Cu vapor laser, an HF chemical laser, a dye laser, a ruby laser, a YAG laser, a glass laser, a titanium-sapphire laser, an alexandrite laser and a GaAlAs array semiconductor laser from the viewpoints of wavelength and output.

The laser beam is preferably oscillated from a laser beam oscillator which is disposed in an array manner. The laser beam from a plurality of laser beam oscillator enables effectively forming a ferromagnetic layer.

A linear velocity of the laser beam at scanning is preferably from 0.1 m/s to 10 m/s and more preferably from 0.2 m/s to 5 m/s for the purpose of effects that a phase transformation is sufficiently performed while ablation is not generated.

It is preferable to provide a laser reflection layer between the support and the nanoparticle layer in view of the fact that there is no effect of heat on the support. The laser reflection layer enables to cut off almost all or all of the laser beam which will reach the substrate, and therefore, it is possible to improve an effect of preventing the support from being deformed or altered thermally.

A material constituting a laser beam reflective layer is not particularly limited as far as it can reflect the laser beam. Examples of the material include Al, Ag, Au, Cu, Mo, Ti, Cr, Ni, Pt, Ta, Pd, SiC, Al+TiO₂ etc., and these are preferably dispersed in a laser beam reflective layer. A laser beam reflective layer can be formed by sputtering or depositing any one of the aforementioned materials. When a thickness of a laser beam reflective layer is too thin, heat is easily diffused, while when a thickness is too thick, a reflectance may be reduced. Therefore, a thickness of the laser beam reflection layer is preferably 30 to 1000 nm and more preferably 50 to 300 nm.

After heating with a laser beam, the organic material in the nanoparticle layer is carbonized. Preferably, a binder is applied on a polymer and allowed to be penetrated therein in order to stabilize the layers.

Examples of the binders include a polyurethane resin; a polyester type resin; a polyamide type resin; a vinyl chloride type resin; an acrylic resin prepared by copolymerizing styrene, acrylonitrile, methylmethaacrylate and the like; a cellulose type resin such as nitrocellulose; an epoxy resin; a phenoxy resin; a polyvinyl alkyral resin such as polyvinyl acetal and polyvinyl butyral; and mixtures thereof Among these resins, polyurethane resin, polyvinyl chloride type resin and acrylic resin are preferable.

After heat treatment, a coercive force of ordered crystallized magnetic nanoparticles is preferably 95.5 to 398 kA/m (1200 to 5000 Oe). When the nanopaticles are applied to a magnetic recording medium, the coercive force is preferably 95.5 to 278.6 kA/m (1200 to 3500 Oe) from view of the fact that a recording head can respond thereto. A particle diameter of nanoparticles is preferably 1 to 100 nm, more preferably 3 to 20 nm, further preferably 3 to 10 nm. When a particle size is too small, it result in superparamagnetism of the nanopaticles and therefore, it is not preferable. For using as a magnetic recording medium, it is preferable to closely pack the nanoparticles, and a standard deviation of a size of nanoparticles is preferably less than 20%, more preferably not more than 15%, further preferably not more than 5% from the viewpoint of increasing a recording capacity.

A magnetic material prepared by a method according to the invention can be favorably used in video tape, computer tape, a floppy (registered mark) disk and a hard disk.

(Magnetic Recording Media)

A magnetic material obtained by a method according to the invention can be favorably used in a magnetic recording medium, having at least one magnetic layer as described above, for example, a magnetic tape such as video tape and computer tape, and a magnetic disk such as floppy (registered mark) disk and hard disk; and the like.

The magnetic recording medium comprises not only a nanoparticle layer (magnetic nanoparticle layer) formed on the magnetic material but also optionally other layers. For example, in the case of the disk, a magnetic layer or a non-magnetic layer can be provided on a surface of an opposite side of the nanoparticle layer. Further, in the case of the tape, it is preferable that a back layer is provided on a surface of an insoluble support of an opposite side of the nanoparticle layer.

For example, by forming an extremely thin protective film on the nanoparticle layer, abrasion resistance is improved and, further, by coating a lubricant on the thus-formed protective film to enhance lubricity, whereby a magnetic recording medium having sufficient reliability can be prepared.

Examples of materials of the protective film include oxides such as silica, alumina, titania, zirconia, cobalt oxide and nickel oxide; nitrides such as titanium nitride, silicon nitride and boron nitride; carbides such as silicon carbide, chromium carbide and boron carbide; and carbon such as graphite and amorphous carbon. Hard non-crystalline carbon, generally called as diamond-like carbon, is particularly preferable.

Since a carbon protective film comprising carbon has an extremely thin thickness and sufficient abrasion resistance and is hard to cause sliding member to be seized, and therefore, the carbon protective film is advantageous as a material for the protective film.

As a method of forming the carbon protective film in a hard disk, a sputtering method is ordinarily, however, for a product on which a continuous film forming is necessary to be performed, such as video tape, there have been proposed various methods using plasma CVD in which a film forming speed is higher than that in the sputtering method. It is preferable that the methods using plasma CVD are applied. Among them, it has been reported that a plasma injection CVD (PI-CVD) method has extremely high film forming speed and a carbon protective film to be obtained by the method is a good-quality protective film having little pinhole (see, for example, JP-A Nos. 61-130487, 63-279426 and 03-113824).

The carbon protective film has a hardness of preferably 1000 Kg/mm² or more and more preferably 2000 Kg/mm² or more in terms of Vickers hardness. Further, it is preferable that the carbon protective film has an amorphous structure and is electrically non-conductive. Still further, when a diamond type carbon (diamond-like carbon) film is used as a carbon protective film, a structure thereof can be confirmed by a Raman spectrographic analysis. In other words, when the diamond type carbon film is measured, the film can be identified by detecting a peak in a range of from 1520 cm⁻¹ to 1560 cm⁻¹. When the structure of the carbon film is deviated from the diamond type structure, the peak detected by the Raman spectrographic analysis is deviated from the above-described range and, as a result, hardness which is suitable for a protective film is decreased.

As carbon materials for forming the carbon protective film, carbon-containing compounds such as alkanes such as methane, ethane, propane and butane; alkenes such as ethylene and propylene; alkynes such as acetylene; and the like are preferably used. Further, a carrier gas such as argon or an additive gas such as hydrogen or nitrogen for improving film quality can optionally be added.

When a thickness of a carbon protective film is great, deterioration of electromagnetic transduction property and reduction in adhesiveness to the magnetic nanoparticle layer are generated, while when a thickness is small, abrasion resistance is insufficient. Therefore, a film thickness is preferably 2.5 to 20 nm, more preferably 5 to 10 nm. In addition, in order to improve adhesiveness between the protective film and the magnetic nanoparticle layer which is to be a substrate, it is preferable to etch a surface of the magnetic nanoparticle layer with an inert gas in advance, or expose those layers to reactive gas plasma such as oxygen etc. to modify the surface.

A magnetic nanoparticle layer may be constructed of overlaid layers in order to improve electromagnetic transduction property, or may have the known non-magnetic ground layer. or intermediate layer under the magnetic nanoparticle layer. In order to improve running durability and corrosion resistance, it is preferable to apply a lubricant or a rust preventing agent to the magnetic nanoparticle layer or protective film as described above. As a lubricant to be added, the known hydrocarbon-based lubricant, fluorine-based lubricant and extreme pressure lubricant can be used.

Examples of the hydrocarbon-based lubricant include carboxylic acids such as stearic acid, oleic acid etc.; esters such as butyl stearate etc.; sulfonic acids such as octadecylsulfonic acid etc.; phosphoric acid esters such as monooctadecyl phosphate etc.; alcohols such as stearyl alcohol, oleyl alcohol etc.; carboxylic acid amides such as stearic acid amide etc.; amines such as stearyl amine etc.; etc.

Examples of the fluorine-based lubricant include lubricants in which a part or all of alkyl groups of the aforementioned hydrocarbon-based lubricants are substituted with a fluoroalkyl group or a perfluoropolyether group. Examples of the perfluoropolyether group include a perfluoromethylene oxide polymer, a perfluoroethylene oxide polymer, a perfluoro-n-propylene oxide polymer (CF₂CF₂CF₂O)ₙ, a perfluoroisopropylene oxide polymer (CF(CF₃)CF₂O)ₙ and a copolymer thereof.

In addition, compounds having a polar functional group such as a hydroxyl group, an ester group or a carboxyl group at a terminal of an alkyl group of a hydrocarbon-based lubricant or in a molecule thereof have the high effect of reducing a friction force, and therefore they are preferable. Further, a molecular weight thereof is 500 to 5000, preferably 1000 to 3000. When the molecular weight is less than 500, volatility is high and lubricating property reduces. On the other hand, when the molecular weight exceeds 5000, a viscosity increases, and therefore, a slider and a disk are easily adsorbed and running stoppage or head crushing happens easily. This perfluoropolyether is specifically commercially available under a trade name of FOMBLIN manufactured by Aujimond, or KRYTOX manufactured by DuPont.

Examples of the extreme pressure additive include phosphoric acid esters such as trilauryl phosphate; phosphorous acid esters such as trilauryl phosphite; thiophosphorous acid ester such as trilauryl trithiophosphite, and thiophosphoric acid esters; sulfur-based extreme-pressure additives such as dibenzyl disulfide; and the like.

The lubricants are used alone, or a plurality of them are used together. As a method of applying the lubricants to a magnetic nanoparticle layer or a protective film, a lubricant may be dissolved in an organic solvent, and the solution obtained may be coated by a wire bar method, a gravure method, a spin coating method, a dip coating method, and the like, or may be adhered by a vacuum deposition method.

Examples of the rust preventing agent include nitrogen-containing heterocycles such as benzotriazole, benzimidazole, purine, pyrimidine etc., and derivatives in which an alkyl group at a side chain etc. is introduced into a mother nucleus of them; nitrogen and sulfur-containing heterocylcles such as benzothiazole, 2-mercaptonebenzothiazole, tetraazaindene ring comound, thiouracil compound etc., and derivatives thereof etc.

As already described above, when a magnetic recording medium is a magnetic tape etc., a back coating layer (backing layer) may be formed on a side that has no magnetic nanoparticle layer on the non-magnetic support. The back coating layer is a layer formed by coating a paint for forming a back coating layer in which a particulate component such as an abrasive and an antistatic agent, and a binder are dispersed in the known organic solvent, on a side that has no a magnetic nanoparticle layer on the non-magnetic support. As the particulate component, various inorganic pigments or carbon black can be used and, as the binder, resins such as nitrocellulose, a phenoxy resin, a vinyl chloride-based resin, polyurethane etc. can be used alone, or may be used by mixing them. Alternatively, the known adhesive layer may be provided on a side on which a nanoparticle disperesion is coated or a side on which a back coating layer is formed.

The magnetic recording medium thus prepared has an average roughness in a range of preferably 0.1 to 5 nm, more preferably 1 to 4 nm in cutoff value of 0.25 mm at a central line of the surface. This is because that it is preferable for a magnetic recording medium for high density recording to provide a surface with such extremely excellent smoothness. Examples of a method of obtaining such surface include a method which comprises forming a magnetic layer, and calendar-treating the layer. Alternatively, the layer may be varnish-treated.

The resulting magnetic recording medium can be used by appropriately punching with a punching machine, or cutting to a desired size by a cutting machine.

(Physical Property)

A coercive force (Hc) of a magnetic layer in the magnetic recording medium according to the invention is preferably 95.5 kA/m (1200 Oe) to 955 kA/m (12000 Oe), more preferably 159 to 478 kA/m (2000 to 6000 Oe). A distribution of the coercive force is preferably narrower, and SFD is preferably 0.5 or less.

### EXAMPLES

The invention will be explained in more detail with reference to Examples, but the invention is not limited thereto.

### [Example 1]

### (Preparation of FePt Alloy Nanoparticles)

The following operation was performed in a highly pure N₂ gas.

An alkaline solution of 12.4 g of Aerosol OT (manufactured by Tokyo Kasei Kogyo Co., Ltd.) dissolved in 120 ml of decane (manufactured by Wako Pure Chemical Industries, Ltd.) was added to a reducing agent aqueous solution of 0.48 g of NaBH₄ (manufactured by Wako Pure Chemical Industries, Ltd.) dissolved in 18 ml of (oxygen scavenged) H₂O and then, mixed to obtain a reverse micelle solution (1).

Further, an alkaline solution of 12.4 g of Aerosol OT dissolved in 120 ml of decane was added to a metal salt aqueous solution of 0.44 g of iron(III) triammonium trioxalate (Fe(NH₄)₃(C₂O₄)₃) (manufactured by Wako Pure Chemical Industries, Ltd.) and 0.41 g of potassium tetrachloro platinate(II) (K₂PtCl₄) (manufactured by Wako Pure Chemical Industries, Ltd.) dissolved in 18 ml of (oxygen scavenged) H₂O, and then, mixed to prepare a reverse micelle solution (2).

An alkaline solution of 3.1 g of Aerosol OT dissolved in 30 ml of decane was added to a metal salt aqueous solution of 0.12 g of NaBH₄ (manufactured by Wako Pure Chemical Industries, Ltd.) dissolved in 4.5 ml of (oxygen scavenged) H₂O, and then, mixed to prepare a reverse micelle solution (3).

An alkaline solution of 3.1 g of Aerosol OT dissolved in 30 ml of decane was added to a metal salt aqueous solution of 0.01 g of Bicine (N,N-bis(2-hydroxyethyl)glycine; manufactured by Dojin Chemical Laboratory) dissolved in 4.5 ml of (oxygen scavenged) H₂O and then, mixed to obtain a reverse micelle solution (4).

The reverse micelle solution (2) was instantly added to the reverse micelle solution (1) while stirring rapidly with an Omni mixer (manufactured by Yamato Scientific Co., Ltd.) at 22° C. Four minutes later, the reverse micelle solution (3) was further added instantly. Further, two minutes later, 3 ml of oleylamine was instantly added. Two minutes later, stirring was changed to stirring with a magnetic stirrer, a temperature was raised to 40° C., the mixture was aged for 110 minutes, and the reverse micelle solution (4) was instantly added, followed by further stirring for 10 minutes. The mixture was cooled to room temperature, to which 3 ml of oleic acid (manufactured by Wako Pure Chemical Industries, Ltd.) was added, and then the solution was mixed and taken out into the atmosphere. In order to destruct the reverse micelle, a mixed solution of 450 ml of H₂O and 450 ml of methanol was added to separate into the aqueous phase and the oily phase. The state where metal nanoparticles are dispersed was obtained in the oily phase. The oily phase was taken out, and washed once with a mixed solution of 900 ml of H₂O and 300 ml of methanol. Thereafter, 2500 ml of methanol was added to cause flocculation in metal nanoparticles, allowing them to sediment. The supernatant was removed, to which 40 ml of heptane (manufactured by Wako Pure Chemical Industries, Ltd.) was added to re-disperse them. Further, precipitation by addition of 200 ml of methanol and dispersion with 40 ml of heptane were repeated twice and, finally, and 15 ml of heptane was added to obtain a solution containing FePt alloy nanoparticles. A composition was Fe/Pt=55/45 atm %.

A decane solution containing 1% by mass of silicone resin (TREFIL R910, manufactured by Toray Dow Corning Silicone) as a fusion inhibitor was added to a FePt alloy nanoparticle-containing solution (solvent: substituted with decane) in which alloy nanoparticles was adjusted to 4% by mass, so that a mass of a silicone resin became 30% relative to a mass of alloy nanoparticles, and the mixture was stirred to prepare a coating solution (1).

A coating solution (1) containing 0.04 mg/ml of FePt alloy nanoparticles was coated on a quartz glass substrate having a thickness of 1.1 mm so that FePt alloy nanoparticles became 0.5 g/m², and then was dried to form a coated film.

The coated film was irradiated with laser beam to form a nanoparticle layer, thereby obtaining a magnetic material A.

| | |
|---|---|
| Semiconductor laser | wavelength 808 nm |
| Laser beam diameter | 1.5 × 180 μm |
| Linear velocity | 0.6 m/s |
| Power | 0.7 W |

### [Example 2]

A magnetic material B was prepared according to the same manner as that of Example 1 except that an organosilica sol (trade name: NANOTEK SiO₂, manufactured by C.I.KASEI. CO., LTD.) was used as a fusion inhibitor.

### [Example 3]

A magnetic material C was prepared according to the same manner as that of Example 1 except that an organotitania sol (trade name: NANOTEK TiO₂, manufactured by C.I. KASEI. CO., LTD.) was used as a fusion inhibitor.

### [Example 4]

A magnetic material D was prepared according to the same manner as that of Example 1 except that a fusion inhibitor was added in an amount of 10% of a mass of alloy nanoparticles.

### [Example 5]

A magnetic material E was prepared according to the same manner as that of Example 1 except that a fusion inhibitor was added in an amount of 5% of a mass of alloy nanoparticles.

### [Example 6]

A magnetic material F was prepared according to the same manner as that of Example 1 except that a fusion inhibitor was added in an amount of 45% of a mass of alloy nanoparticles.

### [Example 7]

A magnetic material G was prepared according to the same manner as that of Example 1 except that a PPTA film (PPTA: polyparaphenyleneterephthalamide, ARAMICA, manufactured by Asahi Kasei Corporation) having a thickness of 40μ was used as a support.

### [Example 8]

A magnetic material H was prepared according to the same manner as that of Example 1 except that a fusion inhibitor was added in an amount of 0.8% of a mass of alloy nanoparticles.

### [Example 9]

A magnetic material I was prepared according to the same manner as that of Example 1 except that a fusion inhibitor was added in an amount of 75% of a mass of alloy nanoparticles.

### [Example 10]

A magnetic material J was prepared according to the same manner as that of Example 1 except that heat treatment was performed at 500° C. for 25 minutes under the nitrogen atmosphere in an electric furnace.

### [Comparative Example 1]

A magnetic material K was prepared according to the same manner as that of Example 1 except that a fusion inhibitor was not added.

### [Comparative Example 2]

A magnetic material L was prepared according to the same manner as that of Example 1 except that toluene was used as a solvent for dispersing alloy nanoparticles, and polystyrene was used as a fusion inhibitor.

### <Evaluation of Property>

(1) Particle diameter: Nanoparticles were scraped down with a spatula from a sample of a magnetic material after laser irradiation, and were dispersed in heptane. The dispersion was placed on a copper mesh and dried to prepare a sample for TEM. A microgram was taken with a transmission electron microscope under the condition of an acceleration voltage of 80 kV, and an average particles diameter and a particular diameter distribution were obtained using image processing system (KS300) manufactured by Carl Zeiss. Results are shown in Table 1.

(2) X-ray diffraction: Nanoparticles were scraped with avoiding the strain with a spatula from a sample of a magnetic material after laser irradiation, so that they were placed on a quartz non-reflective sample plate, and the nanoparticles were dried to prepare a sample for X-ray diffraction. X-ray diffraction was performed with an X-ray diffraction apparatus manufactured by Rigaku Corporation under the conditions of a tube voltage of 50 KV and a tube current of 300 mA by a powder method using a goniometer producing CuKa-ray. A disordered phase and an ordered phase were discriminated from a crystal structure. Results are shown in Table 1.

(3) Magnetic property: As magnetic property of each of Examples 1 to 7 and Comparative Examples 1 to 3, Hc was measured at an applied magnetic field of 790 kA/m (10 kOe) using a high sensitive magnetization vector measuring machine manufactured by Toei Industry Co., Ltd. and a DATA processing apparatus manufactured by the same company. Results are shown in Table 1.

TABLE 1

| | | | | | | Average | | |
|---|---|---|---|---|---|---|---|---|
| | | | | | | particle | Variation | |
| | | | Addition | | | diameter | coefficient | |
| Magnetic | Particle | Fusion | amount | | Heating | (after heat | (after heat | Hc |
| material | composition | inhibitor | (%) | Support | method | treatment) | treatment) | (kA/m) |
| A | FePt | Silicone | 30 | Quartz | Laser | 5.2 nm | 10.0% | 165.9 |
| | | resin | | glass | | | | (2100Oe) |
| B | FePt | Organosilica | 30 | Quartz | Laser | 5.2 nm | 10.1% | 172.2 |
| | | sol | | glass | | | | (2180Oe) |
| C | FePt | Organotitania | 30 | Quartz | Laser | 5.3 nm | 10.2% | 169.9 |
| | | sol | | glass | | | | (2150Oe) |
| D | FePt | Silicone | 10 | Quartz | Laser | 5.2 nm | 9.8% | 186.4 |
| | | resin | | glass | | | | (2360Oe) |
| E | FePt | Silicone | 5 | Quartz | Laser | 5.4 nm | 10.3% | 167.5 |
| | | resin | | glass | | | | (2120Oe) |
| F | FePt | Silicone | 45 | Quartz | Laser | 5.3 nm | 10.1% | 177.8 |
| | | resin | | glass | | | | (2250Oe) |
| G | FePt | Silicone | 30 | PPTA | Laser | 5.4 nm | 10.2% | 183.3 |
| | | resin | | | | | | (2320Oe) |
| H | FePt | Silicone | 0.8 | Quartz | Laser | 9.5 nm | 15.3% | 193.6 |
| | | resin | | glass | | | | (2450Oe) |
| I | FePt | Silicone | 75 | Quartz | Laser | 8.8 nm | 13.8% | 181.7 |
| | | resin | | glass | | | | (2300Oe) |
| J | FePt | Silicone | 30 | Quartz | Electric | 9.6 nm | 13.4% | 184.0 |
| | | resin | | glass | furnace | | | (2330Oe) |
| K | FePt | None | — | Quartz | Laser | 20.3 nm | 30.5% | 195.9 |
| | | | | glass | | | | (2480Oe) |
| L | FePt | Polystyrene | 30 | Quartz | Laser | 22.5 nm | 32.3% | 187.2 |
| | | | | glass | | | | (2370Oe) |

In magnetic materials A to L of Examples 1 to 10 and Comparative Examples 1 and 2, nanoparticles were in an ordered phase, and they were confirmed that those magnetic materials had better magnetic property. In addition, even when a heat resistant polymer was used in a support, no change in a shape was seen (Examples 1 to 10). However, since the effect of a fusion inhibitor was not obtained in Comparative Examples 1 and 2, an average particle diameter and a variation coefficient of a particle diameter became great. On the other hand, in Examples 1 to 10, due to the effect of a fusion inhibitor, particles which have a small size and are monodispersed were produced, and it is seen that materials are promising magnetic materials for enhancing magnetic recording density.

Further, as clear from the results of Examples 1 to 10, the effect of a fusion inhibitor is remarkably manifested at an addition amount of 1 to 50% (Examples 1 to 7), and the effect is more remarkably manifested when heat treatment was performed with laser beam (Examples 1 to 7) than that with an electric furnace (Example 10).

As described the above, according to the invention, a magnetic material which effectively converts an alloy phase of alloy nanoparticles into a ferromagnetic ordered alloy phase without changing quality and shape of a material and without changing a particle diameter of alloy nanoparticles, whether a support is an organic material or an inorganic material, can be obtained.

In the invention, since a nanoparticle dispersion contains a fusion inhibitor, magnetic nanoparticles are not fused by heat treatment due to ferromagnetization. Thereby, magnetic nanoparticles having a desired particle diameter and a magnetic ordered alloy phase can be obtained without changing a particular diameter of nanoparticles.

All publications, patent applications, and technical standards mentioned in this specification are herein incorporated by reference to the same extent as if each individual publication, patent application, or technical standard was specifically and individually indicated to be incorporated by reference.

What is claimed is:

1. A process for manufacturing a magnetic material, comprising: coating a nanoparticle dispersion containing alloy nanoparticles capable of forming a ferromagnetic ordered alloy phase, and a fusion inhibitor on a support to form a coated film of a nanoparticle magnetic layer, and heat-treating the coated film to ferromagnetize the alloy nanoparticles.

2. The process for manufacturing a magnetic material according to claim 1, wherein the fusion inhibitor is an inorganic material capable of withstanding a temperature of at least 500° C., and is soluble in a dispersing solvent of a nanoparticle dispersion.

3. The process for manufacturing a magnetic material according to claim 1, wherein the fusion inhibitor is a non-magnetic metal oxide.

4. The process for manufacturing a magnetic material according to claim 2, wherein the fusion inhibitor is a non-magnetic metal oxide.

5. The process for manufacturing a magnetic material according to claim 1, wherein the fusion inhibitor is at least one inorganic material selected from silica, titania, and polysiloxane.

6. The process for manufacturing a magnetic material according to claim 1, wherein an amount of the fusion inhibitor to be added is 1 to 50% relative to the total volume of the alloy nanoparticles.

7. The process for manufacturing a magnetic material according to claim 1, wherein the alloy nanoparticles are alloy nanoparticles capable of forming a CuAu type or Cu₃Au type ferromagnetic ordered alloy phase.

8. The process for manufacturing a magnetic material according to claim 1, wherein the heat treatment is performed by irradiation with laser beam.

9. The process for manufacturing a magnetic material according to claim 8, wherein the irradiation with laser beam is oscillated from a laser beam oscillator which is disposed in an array manner.

10. A magnetic material comprising a support and a nanoparticle magnetic layer of a nanoparticle dispersion coated thereon, wherein the nanoparticle dispersion comprises alloy nanoparticles capable of forming a ferromagnetic ordered alloy phase and a fusion inhibitor.

11. The magnetic material according to claim 10, wherein a laser reflection layer is provided between the support and the nanoparticle magnetic layer.

12. The magnetic material according to claim 10, wherein the fusion inhibitor is an inorganic material capable of withstanding a temperature of at least 500° C., and is soluble in a dispersing solvent of a nanoparticle dispersion.

13. The magnetic material according to claim 10, wherein the fusion inhibitor is a non-magnetic metal oxide.

14. The magnetic material according to claim 10, wherein the fusion inhibitor is at least one inorganic material selected from silica, titania, and polysiloxane.

15. The magnetic material according to claim 10, wherein an amount of the fusion inhibitor to be added is 1 to 50% relative to the total volume of the alloy nanoparticles.

16. The magnetic material according to claim 10, wherein the alloy nanoparticles are alloy nanoparticles capable of forming a CuAu type or Cu₃Au type ferromagnetic ordered alloy phase.

17. The magnetic material manufactured by the process according to claim 1.

18. A high density magnetic recording medium comprising a magnetic layer containing the magnetic material according to claim 10.

19. The high density magnetic recording medium comprising a magnetic layer containing the magnetic material according to claim 17.
